(19) United States
(12) Patent Application Publication
(10) Pub. No.: US 2023/0385735 A1
(43) Pub. Date: Nov. 30, 2023

(54) SYSTEM AND METHOD FOR OPTIMIZED PREDICTIVE RISK ASSESSMENT

(71) Applicant: Cognizant Technology Solutions India Pvt. Ltd., Chennai (IN)

(72) Inventors: Satyaki Ghosh, Kolkata (IN); Jishan Ali Mondal, Kolkata (IN); Vaskar Baran Saha, Kolkata (IN); Sandip Agarwala, Kolkata (IN); Sayantan Mukherjee, Kolkata (IN)

(21) Appl. No.: 17/902,014

(22) Filed: Sep. 2, 2022

(30) Foreign Application Priority Data
May 26, 2022 (IN) 202241030167

(51) Int. Cl. G06Q 10/06; G06F 8/77

(52) U.S. Cl. CPC G06Q 10/0635; G06F 8/77; G06Q 10/06393

(57) ABSTRACT

The present invention provides for a system and a method for optimized predictive risk assessment of software development lifecycle of projects. The present invention provides for fetching an unstructured attribute dataset and grouping the unstructured attribute dataset based on derived Knowledge Performance Indicator (KPI) scores. The present invention provides for converting the unstructured attribute dataset into a structured attribute dataset by applying pre-defined rules, where each attribute data of the structured attribute dataset is mapped to pre-determined categorical values. The present invention provides for correlating a derived attribute data from the structured attribute dataset with a defined attribute data to derive an accuracy percentage. The present invention provides for combining the KPI scores, the accuracy percentage and the spillover risk values and the defect density values for risk assessment in the software development lifecycle of projects to generate indicators of risks.

### FIELD OF THE INVENTION

The present invention relates generally to the field of data analytics, and more particularly, the present invention relates to a system and a method for optimized risk assessment using predictive analysis.

### BACKGROUND OF THE INVENTION

Implementation of software projects are, typically, fraught with errors and bugs. Errors may take some time to be identified and, once identified, may take additional time to be resolved. Also, errors may result in increased costs, reduced performance, and customer dissatisfaction. Further, large software projects are difficult to manage as many of the problems, defects, issues, and bugs found in the software do not occur until late in the development cycle. Also, shortcuts are taken by software development teams, especially during a time crunch situation where the teams resort to quick, last minute fixes or faulty development and testing rather than raising concerns that leads to quality compromised products that are prone to breakage in real life.

Furthermore, tight coordination is required among development team members in order to deliver a successful software system. However, there are several problems inherent in software development projects that make such coordination difficult. Several software characteristics such as scale, interdependence, and uncertainty lead to unavoidable coordination problems. Also, software systems are becoming increasingly large, thus increasing complexity and interdependencies between modules of the software systems.

Further, software development life cycle models known as agile project management systems require a significant dependency on stable and efficient project management systems that seamlessly track every aspect of product development from inception to product delivery. The agile project management systems, typically, have the option to provide users with a wide variety of well-defined and structured reports i.e. burn down charts, velocity metrics, etc. on the overall progress and health of projects and the corresponding project risks. However, due to the static nature and design limitations, many a times the agile project management systems fail in their objective to showcase root causes of failure and roadblocks.

Typically, agile project management systems may generate and read reports only after events that caused failures have already occurred. The reports are meant to be viewed in retrospection rather than immediate rectification by development teams in charge. Also, there is no way to capture technical gaps in development and testing created by software development teams to meet strict deadline. The reports are primarily designed to show effect rather than the cause e.g. primarily showing that the team is on track and progress is as expected. Further, traditional metrics like burn down, progress velocity etc. are designed to illustrate overall completion status of work items versus target but do not factor in outcome, and therefore underlying risk of technical shortcomings within product continue to exist.

In light of the above-mentioned drawbacks, there is a need for a system and a method for optimized risk assessment in a software development lifecycle. Further, there is a need for a system and method for predictive risk assessment to monitor software development cycle in real time.

### SUMMARY OF THE INVENTION

In various embodiments of the present invention, a system for optimized predictive risk assessment of software development lifecycle of projects is provided. The system comprises a memory storing program instructions and a processor executing program instructions stored in the memory. The system comprises a risk estimation engine executed by the processor and configured to fetch an unstructured attribute dataset and group the unstructured attribute dataset based on derived Knowledge Performance Indicator (KPI) scores. The risk estimation engine is configured to convert the unstructured attribute dataset into a structured attribute dataset by applying pre-defined rules where each attribute data of the structured attribute dataset is mapped to pre-determined categorical values. The risk estimation engine is configured to correlate a derived attribute data from the structured attribute dataset with a defined attribute data to derive an accuracy percentage. The accuracy percentage signifies a potential risk to subsequent tasks in the software development lifecycle of projects. The risk estimation engine is configured to implement a decision tree structure using the structured attribute dataset to predict spillover risk values. The risk estimation engine is configured to apply an iterative logic to predict defect density values based on the structured attribute dataset. The risk estimation engine is configured to combine the KPI scores, the accuracy percentage and the spillover risk values and the defect density values for risk assessment in the software development lifecycle of projects to generate indicators of risks.

In various embodiments of the present invention, a method for optimized predictive risk assessment of software development lifecycle of projects is provided. The method comprises fetching an unstructured attribute dataset and grouping the unstructured attribute dataset based on derived Knowledge Performance Indicator (KPI) scores. The method comprises converting the unstructured attribute dataset into a structured attribute dataset by applying pre-defined rules where each attribute data of the structured attribute dataset is mapped to pre-determined categorical values. The method comprises correlating a derived attribute data from the structured attribute dataset with a defined attribute data to derive an accuracy percentage. The accuracy percentage signifies a potential risk to subsequent tasks in the software development lifecycle of projects. The method comprises implementing a decision tree structure using the structured attribute dataset to predict spillover risk values. The method comprises applying an iterative logic to predict defect density values based on the structured attribute dataset and combining the KPI scores, the accuracy percentage and the spillover risk values and defect density values for risk assessment in the software development lifecycle of projects to generate indicators of risks.

In various embodiment of the present invention, a computer program product is provided. The computer program product comprises a non-transitory computer-readable medium having computer program code stored thereon, the computer-readable program code comprising instructions that, when executed by a processor, causes the processor to fetch an unstructured attribute dataset and group the unstructured attribute dataset based on derived Knowledge Performance Indicator (KPI) scores. The unstructured attribute dataset is converted into a structured attribute dataset by applying pre-defined rules. Each attribute data of the structured attribute dataset is mapped to pre-determined categorical values and a derived attribute data is correlated from the structured attribute dataset with a defined attribute data to derive an accuracy percentage. The accuracy percentage signifies a potential risk to subsequent tasks in the software development lifecycle of projects and a decision tree structure is implemented using the structured attribute dataset to predict spillover risk values. An iterative logic is applied to predict defect density values based on the structured attribute dataset. The KPI scores, the accuracy percentage and the spillover risk values and defect density values are combined for risk assessment in the software development lifecycle of projects to generate indicators of risks.

### BRIEF DESCRIPTION OF THE ACCOMPANYING DRAWINGS

The present invention is described by way of embodiments illustrated in the accompanying drawings wherein:

FIG. 1 is a block diagram of a system for predictive risk assessment, in accordance with an embodiment of the present invention;

FIG. 2A illustrates a structured attribute dataset, in accordance with an embodiment of the present invention;

FIG. 2B illustrates correlation between defined story point and derived story point, in accordance with an embodiment of the present invention;

FIG. 3 illustrates a decision tree structure, in accordance with an embodiment of the present invention;

FIG. 4 is a flowchart for predictive risk assessment, in accordance with an embodiment of the present invention; and

FIG. 5 illustrates an exemplary computer system in which various embodiments of the present invention may be implemented.

### DETAILED DESCRIPTION OF THE INVENTION

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

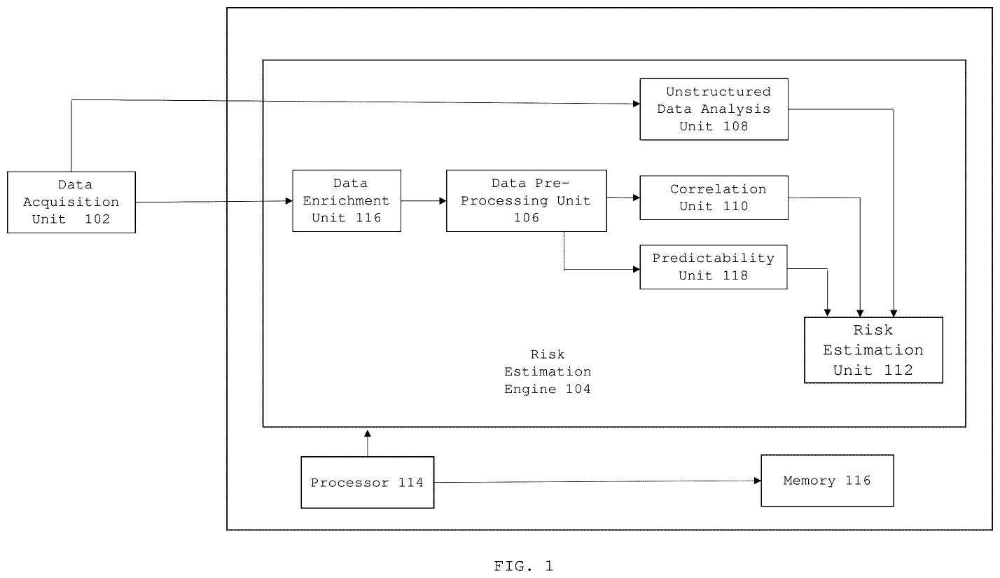

FIG. 1 is a block diagram of a system 100 for predictive risk assessment, in accordance with various embodiments of the present invention.

In an embodiment of the present invention, the system 100 comprises a data acquisition unit 102 and a risk estimation engine 104. In an embodiment of the present invention, the risk estimation engine 104 comprises a data enrichment unit 116, a data pre-processing unit 106, an unstructured data analysis unit 108, a correlation unit 110, a predictability unit 118 and a risk estimation unit 112. The units of the system 100 operate in conjunction with each other for predictive risk assessment, in accordance with an embodiment of the present invention. The units of the system 100 are operated via a processor 114 specifically programmed to execute instructions stored in a memory 116 for executing respective functionalities of the units of the system 100.

In an embodiment of the present invention, the system 100 may be implemented in a cloud computing architecture in which data, applications, services, and other resources are stored and delivered through shared data-centres. In an exemplary embodiment of the present invention, the functionalities of the system 100 are delivered to a user as Software as a Service (SaaS) or Platform as a Service (PaaS) over a communication network.

In another embodiment of the present invention, the system 100 may be implemented as a client-server architecture. In this embodiment of the present invention, a client terminal accesses a server hosting the system 100 over a communication network. The client terminals may include but are not limited to a smart phone, a computer, a tablet, microcomputer or any other wired or wireless terminal. The server may be a centralized or a decentralized server. The server may be located on a public/private cloud or locally on a particular premise.

In an embodiment of the present invention, the data acquisition unit 102 stores an unstructured attribute dataset in real-time for each work item documented in a project for a currently running software development lifecycle project. In an example, the software development lifecycle project is an agile project. In an exemplary embodiment of the present invention, the unstructured attribute dataset includes, data relating to project requirement details, task objectives, worklog, watchers, attachments, acceptance criteria, comments, sprint, priority/severity, story points, team involvement and communication threads.

In another exemplary embodiment of the present invention, the unstructured attribute dataset includes data related to a plurality of communication threads active in the agile project that is directly proportional to complexity in the agile project. The communication threads comprise unstructured data that is generated by a team on a daily basis but may be unnoticed. The communication thread holds critical insights related to progress, challenges, workarounds, status and other essential technical details. In another embodiment of the present invention, the data acquisition unit 102 stores historical unstructured attribute dataset relating to the work item documented for past agile projects. In an exemplary embodiment of the present invention, the data acquisition unit 102 is a management tool, such as, a Jira project management tool.

In an embodiment of the present invention, the unstructured data analysis unit 108 is configured to fetch the unstructured attribute dataset from the data acquisition unit 106. The unstructured data analysis unit 108 groups the unstructured attribute dataset to create a grouped attribute dataset including categories, such as, a positive, a negative, a mixed and a neutral grouped sentiment dataset. The grouped attribute dataset illustrates true team dynamics that may be hidden from reports based on front-end updates. In an embodiment of the present invention, the grouped attribute dataset is created based on derived Knowledge Performance Indicator (KPI) scores. In an exemplary embodiment of the present invention, a shift in dynamics may be used in derivation of the KPI scores of team performances. The KPI scores indicate the teams' response on performances related to tasks executed. In an exemplary embodiment of the present invention, the positive sentiment dataset refers to project progress. In another exemplary embodiment of the present invention, the negative sentiment dataset relates to instances such as internal team friction. In yet another exemplary embodiment of the present invention, the mixed sentiment dataset corresponds to work in progress, opinion of multiple people, needs analysis. In yet another exemplary embodiment of the present invention, the neutral sentiment dataset represents passive attitude due to any blocker or dependency with external entities for which no ownership is claimed.

In an embodiment of the present invention, the KPI scores are used to correlate individual team member's sentiments to compliment risk of current and future tasks based on their intra and inter team communications. The correlation information is employed to analyse a collective project risk based on pre-defined rules to determine subjectivity, polarity and context. In an example, the pre-defined rules may be as illustrated below:
Positivity Score: “Good”—1, “Better—2”, “Best”—3.
Negativity Score: “Bad”—1, “Worse”—2, “Worst”—3.

In an embodiment of the present invention, the grouping of unstructured attribute dataset is achieved by running each communication thread of the unstructured attribute dataset through a sequence of computational linguistics techniques such as stemming, followed by tokenization to create the grouped attribute dataset. The grouped attribute dataset is tagged to a common part-of-speech and is parsed based on lexicons. The unstructured data analysis unit 108 is configured to detect risks and initiate appropriate corrective actions on instances of continuous non-positive grouped attribute outputs from a set of tasks that indicates underlying impediments, which aids in KPI score analysis.

In another embodiment of the present invention, the unstructured data analysis unit 108 is configured to perform KPI score analysis using Natural Language Processing (NLP) to aid risk analysis. In the NLP analysis, the communication threads are broken down into sub-component parts and these parts are individually validated to identify sentiment bearing phrases through word associations. Depending on the validation, each phrase in the sub-component parts matching the sentiment criteria (positive, negative, mixed, neutral), is assigned a KPI score that is proportional to a degree to which a category of sentiment is expressed. In an exemplary embodiment of the present invention, in the event, communication threads are identified as having multiple sentences, and are identified as having KPI scores across multiple sentiments, such communication threads are grouped under the mixed grouped sentiment dataset.

In another exemplary embodiment of the present invention, in the event it is determined that KPI scores are low in the communication threads based on the analysis and is spread out equally over all categories, such communication threads are grouped under the neutral grouped sentiment dataset. In yet another exemplary embodiment of the present invention, statements, notifications, passive discussions are also grouped under the neutral grouped sentiment dataset. The grouping of the attribute dataset and the KPI score aids in correlating individual team member's sentiments to compliment risk of current or future tasks based on the communication threads.

In an embodiment of the present invention, the KPI score analysis employs both supervised and unsupervised machine learning techniques such as classification algorithms like naive bayes, regression, Support Vector Machine (SVM), neural networks and deep learning to improve and automate the low-level text analytics functions. Examples of low-level text analytics functions, include, but are not limited to, part of speech and word association tagging i.e., “good progress”, “wonderful teamwork”, “awful performance”, “horrible data quality”. The unstructured data analysis unit 108 is trained to identify nouns by utilising the unstructured datasets of text documents containing pre-tagged examples. Using the unstructured datasets, the unstructured data analysis unit 108 is configured to learn what nouns look like in a communication thread and once trained it is used to identify other parts of speech.

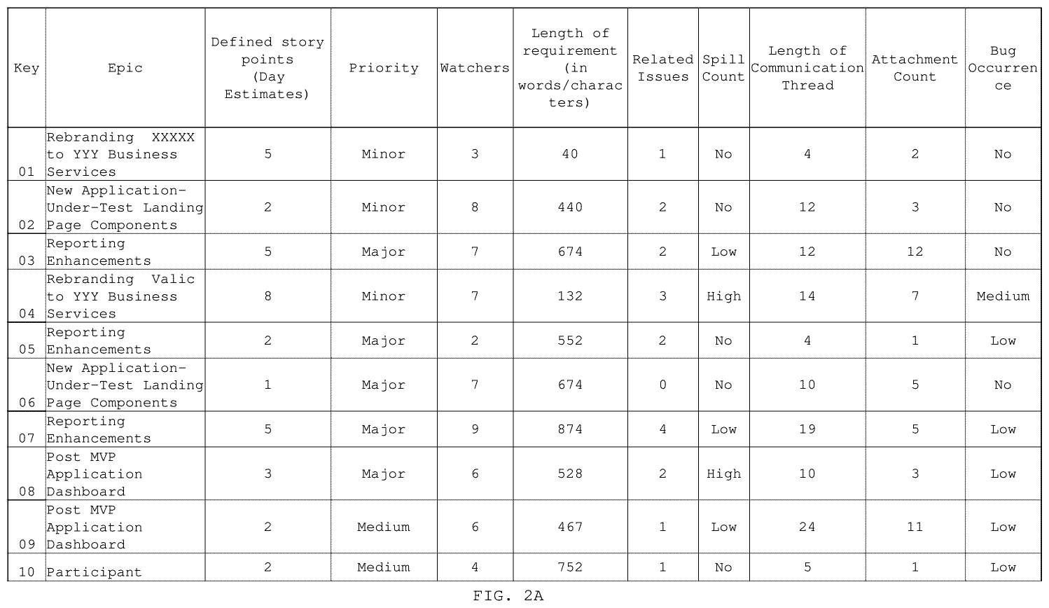

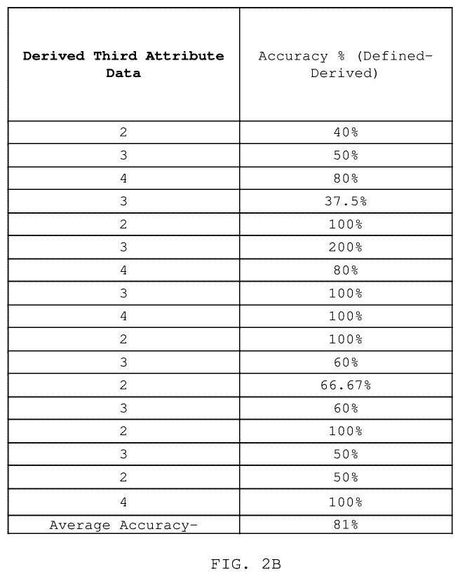

In another embodiment of the present invention, the data enrichment unit 116 is configured to fetch the unstructured attribute dataset from the data acquisition unit 102 and convert the unstructured dataset into a structured attribute dataset by applying pre-defined rules. In an example, FIG. 2A illustrates a structured attribute dataset comprising a plurality of fields of attribute data. In an exemplary embodiment of the present invention, the structured attribute dataset comprises a first attribute data defined as key and representing unique requirement identifiers assigned by a standard project management system corresponding to the software development lifecycle of projects. In an example, the standard project management system corresponds to an agile methodology of a software development lifecycle project. In another exemplary embodiment of the present invention, the structured attribute dataset comprises a second attribute data defined as epic and representing base requirements that is provided by a team that is split at a functional or a technical level. Further, the base requirements include modules and segments associated with User Interface (UI), database connectivity, error control, reporting that are required to build a software system corresponding to the software development lifecycle of projects.

In another embodiment of the present invention, the structured attribute dataset comprises a third attribute data that is defined as story points that denote a count of number of days for completing technical or functional requirements in a work item. In an example, the third attribute data is scaled in between a value of 1-8 days. In another embodiment of the present invention, the structured attribute dataset comprises a fourth attribute data that is defined as priority representing urgency of work items, sequence in which tasks are to be accomplished and a level of significance of the work items. Further, the fourth attribute data may be depicted as a major, a medium, a minor and a rush in a scale, where rush represents an ad-hoc requirement. In another exemplary embodiment of the present invention, the structured attribute dataset comprises a fifth attribute data defined as a watcher representing a count of people that have worked or are working on the work item. Further, as complexity in the software development lifecycle of projects increases, the count of the fifth attribute data increases, due to increase in dependencies.

In another exemplary embodiment of the present invention, the structured attribute dataset comprises a sixth attribute data defined in terms of length of requirement representing length of a field in project management system comprising textual description of the technical and functional requirements in words and characters. In another embodiment of the present invention, the structured attribute dataset comprises a seventh attribute data defined as related issues representing a count of number of similar work items, tasks, and bugs that have dependencies on work items, where a higher count indicates a higher complexity. Further, the seventh attribute data is determined by taking count of related issues and in case if related issues with one requirement is high, complexity is also determined to be higher.

In another exemplary embodiment of the present invention, the structured attribute dataset comprises an eighth attribute data defined as spill count representing a count of number of times a closure of a work item is postponed on account of the work item not being completed within its due date. In an exemplary embodiment of the present invention, the eighth attribute is a count of number of times the work item is not completed on time. Further, the eighth attribute may be represented in terms of ‘no’ (spill count is zero), ‘low’ (spill count is one and requirement is completed), and ‘high’ (spill count is more than one and requirement is completed). In another embodiment of the present invention, the spill count may have binary values (Yes, No). In an embodiment of the present invention, the spill count may be configurable as per instructions provided by the user.

In another exemplary embodiment of the present invention, the structured attribute dataset comprises a ninth attribute data defined as a length of communication thread representing a count of number of comments logged amongst team members in a work item. The number of comments is determined by number of people communicating in communication threads associated with the structured attribute dataset. In another embodiment of the present invention, the structured attribute dataset comprises a tenth attribute data defined as attachment count representing an attachment count of artifacts signifying complexity within a work item, where a higher count of attachments indicates complexity in the work item. In another embodiment of the present invention, the structured attribute dataset comprises an eleventh attribute data defined as bug occurrences representing a count of defects found in a work item. The eleventh attribute represents bug occurrences in the unstructured data in terms of category of defects. The eleventh attribute data is represented in terms of, 0=No|1=Low|2 to 3=Medium|4 to 10=High|>10=very High. In another embodiment of the present invention, the eleventh attribute data may be configurable as per instructions provided by the user.

In an embodiment of the present invention, the data pre-processing unit 106 fetches the structured attribute dataset from the data enrichment unit 116 and pre-processes the attribute dataset by removing occurrences of typos and null values, erroneous data capture, duplicity issues, special character handling, miscellaneous unrelated attributes etc.

In an embodiment of the present invention, the data pre-processing unit 106 processes the structured attribute dataset by performing standardisation of the structured attribute dataset via a z-transform technique to generate a scaled attribute data. The z-transform is used to represent variability in one or more attribute data in the structured attribute dataset. Further, the structured attribute dataset is scaled using z-transform to remove scaling biasness. In an exemplary embodiment of the present invention, the Z-transform technique is executed by calculating a standard score as mentioned below:

Z=(x−μ)/σ
Z=standard score
x=observed attribute value
μ=mean of the attribute list
σ=standard deviation of the attribute list

In an embodiment of the present invention, after standardisation of the structured attribute dataset, a plurality of standardised attributes is removed from the structured attribute dataset by the data pre-processing unit 106, along with a Personal Identifiable Information (PII) and sensitive information through masking or conversion to metadata. In an embodiment of the present invention, the correlation unit 110 is configured to fetch the pre-processed structured attribute dataset from the pre-processing unit 106 to correlate the derived attribute data with the defined attribute data to identify a significant gap in a derived story point and the defined story point that signifies a gap in an estimation analysis and consequently the potential risk to subsequent tasks.

In an exemplary embodiment of the present invention, the derived attribute data is a derived third attribute data that represents derived story points, which is correlated with the defined story point, as illustrated in FIG. 2B. In an embodiment of the present invention, the derived third attribute data is a rescaled value of a complexity noise that is determined based on the pre-processed structured attribute dataset considering each attribute data. Further the correlation unit 110 is configured to rescale the value of the derived story point to a value of 1-8. In an embodiment of the present invention, the correlation unit 110 correlates the derived third attribute data with the defined third attribute data to derive an accuracy percentage. Further, a significant gap in the derived third attribute data and defined third attribute data signifies gap in estimation analysis and signifies a potential risk to subsequent development as a large amount of time or effort is required to accomplish a task. In an example, FIG. 2B illustrates derivation of the accuracy percentage.

In another embodiment of the present invention, the predictability unit 118 is configured to fetch the pre-processed structured attribute dataset from the data pre-processing unit 106 and execute a predictability model on the pre-processed structured attribute dataset based on pre-defined values. In an exemplary embodiment of the present invention, the predictability unit 118 is configured to map each attribute data of the structured attribute dataset using the predictability model to different categorical values, as illustrated herein below:
1) Spillover risk values: Values: High, Low, No
2) Defect density: Values: High, medium, low, No.

In an embodiment of the present invention, the predictability unit 118 is configured to create a decision tree structure and traverse decision nodes in the decision tree structure recursively using the predictability model. The predictability unit 118 is configured to select an optimal split in the structured attribute dataset at each level in the decision tree structure until further splits are possible. The traversal of the decision tree structure is not limited by binary splits thereby providing an option to produce a more branched and optimized tree. For each of the attribute data, the predictability unit 118 produces a separate branching of the decision tree structure by default. In an embodiment of the present invention, the predictability unit 118 employs an entropy reduction to perform optimal splits in the structured attribute dataset. In an exemplary embodiment of the present invention, the predictability unit 118 is configured to implement the decision tree structure to train a supervised learning model using the structured attribute dataset fetched from the data pre-processing unit 106.

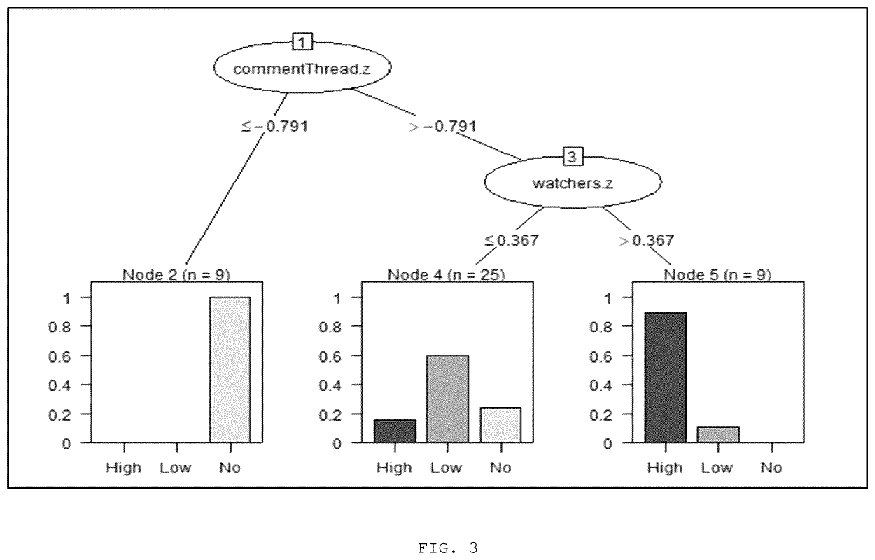

In an embodiment of the present invention, the predictability unit 118 is configured to construct the decision tree structure by selecting an attribute data of the structured attribute dataset as a parent root node and a parameter for splitting the decision tree structure to predict spillover risk values. The spillover risk values indicate that an assigned task is spilled over an assigned deadline and is causing delay in the software development lifecycle projects. In an exemplary embodiment of the present invention, the predictability unit 118 is configured to split the parent root node into child nodes based on pre-defined threshold values. In an example, the predictability unit 118 determines a maximum information retention (gain) for determining spillover risk values that is obtained when a branching point (node) is created for the selected attribute data. In an example, FIG. 3 illustrates the decision tree structure where attribute data of structured attribute dataset is used for splitting of the decision tree structure. In an exemplary embodiment of the present invention, in the event it is determined that scaled value of the selected attribute is <=(−0.791), then attribute records fall on one side of the branch.

In another exemplary embodiment of the present invention, in the event a spillover is determined, the risk associated with the attribute record is classified as “High” and “Low”. In case the spillover is not determined, the risk associated with the attribute record is classified as “No”. Further, branching of the decision tree leads to derivation of learning pattern that may be applied to records of the structured attribute datasets where the records may be classified as a risk or a non-risk record. In an exemplary embodiment of the present invention, as illustrated in FIG. 3, all the records where the normalized and scaled value of the attribute is >(−0.791), fall on other branch where the risk classification is not determined. Further, a process of determining information retention is repeated leading to iterative nature of the predictability model and a second new attribute is determined and a second branching point (node) created. The remainder of the structured attribute dataset is placed on either side of the new branch, as illustrated herein below:
1) Normalized and scaled value of the attribute is <=(0.367), dominant classification of spillover risk=Low
2) Normalized and scaled value of the attribute is >(0.367), dominant classification spillover risk=High

In an embodiment of the present invention, for all values of the structured attribute dataset provided, the predictability unit 118 is configured to apply an iterative logic to predict defect density values in the software development lifecycle of projects. The defect density values are predicted using a decision tree-based classifier with a target variable set to a derived project attribute where bug occurrences indicate number of valid defects found. A plurality of defect data items is derived from the attribute dataset collected by the predictability unit 118 and respective categorical indexes starting from ‘Low’ to ‘High’ are assigned for each historic task. In an exemplary embodiment of the present invention, the structured attribute data set is re-used to predict defect density on a set of current or future tasks.

In an embodiment of the present invention, the risk estimation unit 112 is configured to fetch the KPI scores from the unstructured data analysis unit 108, the accuracy percentage from the correlation unit 110 and spillover risk values and defect density values from the predictability unit 118 and combine the KPI scores, the accuracy percentage and the spillover risk values and defect density values for risk assessment in the software development lifecycle of projects to generate indicator of risks. Advantageously, the indicator of risks indicate chances/likelihood of spillover in projects, probability of defect detection and helps in detecting causes for delay in the projects. Further, the indicators of risk generated by the risk estimation unit 112 enables effective and faster mitigation of causes responsible for delay in projects, thereby minimising risks and improving overall performance of the software development cycle in real time.

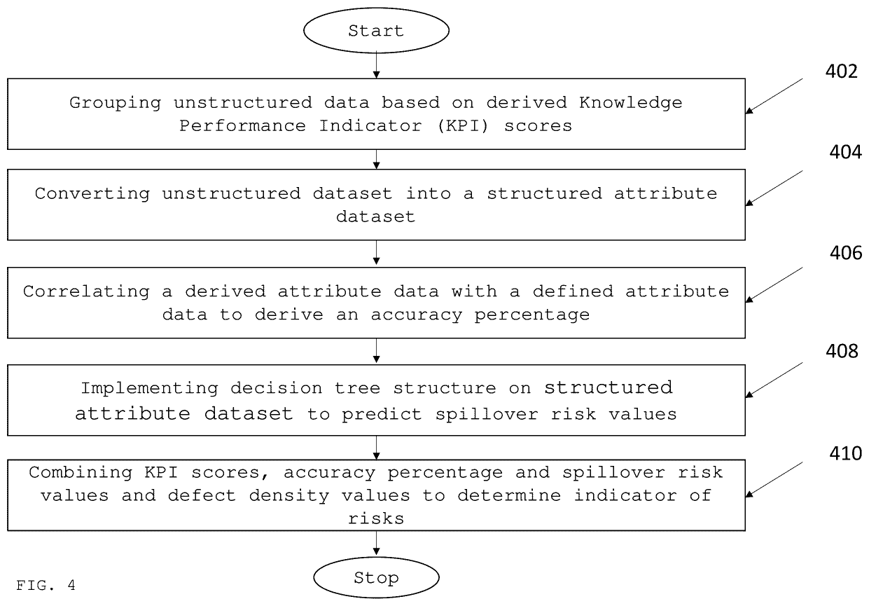

FIG. 4 is an exemplary flowchart illustrating a method for predictive risk assessment.

At step 402, the unstructured data is grouped based on derived Knowledge Performance Indicator (KPI) scores. In an embodiment of the present invention, the unstructured attribute dataset is grouped into a positive, a negative, a mixed and a neutral grouped sentiment dataset. The grouped dataset illustrates true team dynamics that may be hidden from reports based on front-end updates. Further, a shift in dynamics may be used in derivation of Knowledge Performance Indicator (KPI) scores. The KPI scores indicate the teams' response on performances related to tasks executed. In an exemplary embodiment of the present invention, the positive sentiment dataset refers to project progress. In another exemplary embodiment of the present invention, the negative sentiment dataset relates to instances such as internal team friction. In yet another exemplary embodiment of the present invention, the mixed sentiment dataset corresponds to work in progress, opinion of multiple people, needs analysis and neutral sentiment dataset represents passive attitude due to any blocker or dependency with external entities for which no ownership is claimed.

In an embodiment of the present invention, the KPI scores are used to correlate individual team member's sentiments to compliment risk of current and future tasks based on their intra and inter team communications. The correlation information is employed to analyse a collective project risk based on pre-defined rules to determine subjectivity, polarity and context. In an example, the pre-defined rules may be as illustrated below:
Positivity Score: “Good”—1, “Better—2”, “Best”—3.
Negativity Score: “Bad”—1, “Worse”—2, “Worst”—3.

In an embodiment of the present invention, grouping of unstructured attribute dataset is achieved by running each communication thread of the unstructured attribute dataset through a sequence of computational linguistics techniques such as stemming, followed by tokenization to create the grouped attribute dataset. The grouped attribute dataset is tagged to a common part-of-speech and is parsed based on lexicons. The risks are detected, and appropriate corrective actions are initiated on instances of continuous non-positive grouped attribute outputs from a set of tasks that indicates underlying impediments, which aids in KPI score analysis.

In an embodiment of the present invention, KPI score analysis is performed using Natural Language Processing (NLP) to aid risk analysis. In the NLP analysis, the communication threads are broken down into sub-component parts and these parts are individually validated to identify sentiment bearing phrases through word associations. Depending on the validation, each phrase in the sub-component parts matching the sentiment criteria is assigned the KPI score that is proportional to a degree to which a category of sentiment is expressed. In an exemplary embodiment of the present invention, in the event, the communication threads are identified as having multiple sentences, and are identified as having KPI scores across multiple sentiments such communication threads are grouped under the mixed grouped sentiment dataset.

In another exemplary embodiment of the present invention, in the event it is determined that KPI scores are low in the communication threads based on the analysis and is spread out equally over all categories, such communication threads are grouped under the neutral grouped sentiment dataset. In yet another exemplary embodiment of the present invention, statements, notifications, passive discussions are also grouped under the neutral grouped sentiment dataset. The grouping of the attribute dataset and the KPI score aids in correlating individual team member's sentiments to compliment risk of current or future tasks based on the communication threads.

In an embodiment of the present invention, the KPI score analysis employs both supervised and unsupervised machine learning techniques such as classification algorithms like naive bayes, regression, Support Vector Machine (SVM), neural networks and deep learning to improve and automate the low-level text analytics functions. Examples of low-level text analytics functions, include, but are not limited to, part of speech and word association tagging i.e., “good progress”, “wonderful teamwork”, “awful performance”, “horrible data quality”. The unstructured data analysis unit 108 is trained to identify nouns by utilising the unstructured datasets of text documents containing pre-tagged examples. Using the unstructured datasets, it is learnt what nouns look like in a communication thread and once trained it is used to identify other parts of speech.

At step 404, the unstructured dataset is converted into a structured attribute dataset. In an exemplary embodiment of the present invention, the structured attribute dataset comprises a first attribute data representing unique requirement identifiers assigned by a standard project management system corresponding to the software development lifecycle of projects. In an example, the standard project management system corresponds to an agile methodology of a software development lifecycle project. In another exemplary embodiment of the present invention, the structured attribute dataset comprises a second attribute data representing base requirements that is provided by a team that is split at a functional or a technical level. Further, the base requirements include modules and segments associated with User Interface (UI), database connectivity, error control, reporting that are required to build a software system corresponding to the software development lifecycle of projects.

In another embodiment of the present invention, the structured attribute dataset comprises a third attribute data that denotes a count of number of days for completing technical or functional requirements in a work item. In an example, the third attribute may be defined as story point data that is scaled in between a value of 1-8 days. In another embodiment of the present invention, the structured attribute dataset comprises a fourth attribute data that represents urgency of work items, sequence in which tasks shall be accomplished and level of significance of the work items. Further, the fourth attribute data may be represented in a scale of major, medium, minor and rush, where rush is for an ad-hoc requirement. In another exemplary embodiment of the present invention, the structured attribute dataset comprises a fifth attribute data representing a count of people that have worked or are working on the work item. Further, as complexity in the software development lifecycle of projects increases, the count of the fifth attribute data increases.

In another exemplary embodiment of the present invention, the structured attribute dataset comprises a sixth attribute data that represents length of a field in project management system comprising textual description of the technical and functional requirements in words and characters. In another embodiment of the present invention, the structured attribute dataset comprises a seventh attribute data that denotes a count of number of similar work items, tasks and bugs that have dependencies on work item, where a higher count indicates a higher complexity. Further, the seventh attribute data is determined by taking count of related issues and in case if related issues with one requirement is high, complexity is also determined to be higher.

In another exemplary embodiment of the present invention, the structured attribute dataset comprises an eighth attribute that denotes a count of number of times a closure of a work item is postponed on account of the work item not being completed within its due date. In an exemplary embodiment of the present invention, the eighth attribute is represented as a spill count that is a count of number of times the work item is not completed on time. Further, the eight attribute may be represented in terms of ‘no’ (spill count is zero), ‘low’ (spill count is one and requirement is completed), and ‘high’ (spill count is more than one and requirement is completed). In another embodiment of the present invention, the spill count may have binary values (Yes, No). In an embodiment of the present invention, the spill count may be configurable as per instructions provided by the user.

In another exemplary embodiment of the present invention, the structured attribute dataset comprises a ninth attribute data that denotes a count of number of comments logged amongst team members in a work item. The number of comments is determined by number of people communicating in the communication threads associated with the structured attribute dataset. In another embodiment of the present invention, the structured attribute dataset comprises a tenth attribute data that denotes an attachment count of artifacts signifying complexity within a work item, where a higher count of attachments indicates complexity in the work item. In another embodiment of the present invention, the structured attribute dataset comprises an eleventh attribute data denoting a count of defects found in a work item. The eleventh attribute represents bug occurrences in the unstructured data in terms of category of defects. The eleventh attribute data is represented in terms of, 0=No|1=Low|2 to 3=Medium|4 to 10=High|>10=very High. In another embodiment of the present invention, the eleventh attribute data may be configurable as per instructions provided by the user.

In an embodiment of the present invention, the attribute dataset is pre-processed by removing occurrences of typos and null values, erroneous data capture, duplicity issues, special character handling, miscellaneous unrelated attributes etc. In another embodiment of the present invention, the structured attribute dataset is processed by performing standardisation of the structured attribute dataset via a z-transform technique to generate a scaled attribute data, where the z-transform is used to represent variability in one or more attribute data in the structured attribute dataset. Further, the attribute dataset is scaled using z-transform to remove scaling biasness. In an exemplary embodiment of the present invention, the Z-transform method is executed by calculating a standard score as mentioned below:

Z=(x−μ)/σ
Z=standard score
x=observed attribute value
μ=mean of the attribute list
σ=standard deviation of the attribute list

In an embodiment of the present invention, after standardisation of the structured attribute dataset, a plurality of standardised attributes is removed from the structured attribute dataset, along with a Personal Identifiable Information (PII) and sensitive information through masking or conversion to metadata.

At step 406, a derived attribute data is correlated with a defined attribute data to derive an accuracy percentage. In an embodiment of the present invention, the pre-processed structured attribute dataset is fetched, and the third attribute data (story points) is derived from the pre-processed structured attribute dataset. In an embodiment of the present invention, the derived story point is a rescaled value of a complexity noise that is determined based on the pre-processed structured attribute dataset considering all the attribute data. In an exemplary embodiment of the present invention, the value of derived story point is rescaled to a value of 1-8. In an embodiment of the present invention, the derived story point data is correlated with a defined story point data to derive an accuracy percentage. Further, a significant gap in derived story point and defined story point signifies gap in estimation analysis, consequently signifies a potential risk to subsequent development.

At step 408, a decision tree structure is implemented on the structured attribute dataset to predict spillover risk values. In an embodiment of the present invention, the pre-processed structured attribute dataset is fetched and a predictability model is executed on the structured attribute dataset based on pre-defined values. In an exemplary embodiment of the present invention, each attribute data of the structured attribute dataset is mapped using the predictability model to different categorical values, as illustrated herein below:
1) Spillover risk values: High, Low, No
2) Defect density values: High, medium, low, No.

In an embodiment of the present invention, a decision tree structure is created and decision nodes in the decision tree structure are traversed recursively using the predictability model. Further, an optimal split in the structured attribute dataset is selected at each level in the decision tree structure until further splits are possible. The traversal of the decision trees is not limited by binary splits thereby providing an option to produce a more branched and optimized tree. For each of the attribute data, a separate branching of the decision tree is produced by default. In an exemplary embodiment of the present invention, an information gain technique such as an entropy reduction is employed to perform optimal splits in the structured attribute dataset.

In an embodiment of the present invention, the decision tree is constructed by selecting an attribute data of the structured attribute dataset as a parent root node and a significant parameter for splitting the decision tree to predict spillover risk values. In an exemplary embodiment of the present invention, the spillover risk values indicate that an assigned task is spilled over an assigned deadline and is causing delay in software development lifecycle projects. In an exemplary embodiment of the present invention, the parent root node is split into child nodes based on pre-defined threshold values. In an example, a maximum information retention (gain) is determined for determining spillover risk values that is obtained when branching point (node) is created on the selected attribute data.

In an embodiment of the present invention, for all values of the structured attribute dataset provided, an iterative logic is applied to predict defect density values in the software development lifecycle of projects. In an exemplary embodiment of the present invention, the defect density values are predicted using a decision tree-based classifier with a target variable set to a derived project attribute where bug occurrences indicate number of valid defects found. A plurality of defect data items is derived from the attribute dataset and respective categorical indexes starting from ‘Low’ to ‘High’ are assigned for each historic task. In an exemplary embodiment of the present invention, the structured attribute data set is re-used to predict defect density on a set of current or future tasks.

At step 410, KPI scores, accuracy percentages and spillover risk values and defect density values are combined for risk assessment. In an embodiment of the present invention, KPI scores, accuracy percentages and spillover risk values and defect density values are combined to detect causes for delay in the projects as indicator of risks. Advantageously, the indicator of risks indicate chances/likelihood of spillover in projects, probability of defect detection and helps in detecting causes for delay in the projects. Further, the indicators of risk generated by the risk estimation unit 112 enables effective and faster mitigation of causes responsible for delay in projects, thereby minimising risks and improving overall performance of the software development cycle in real time.

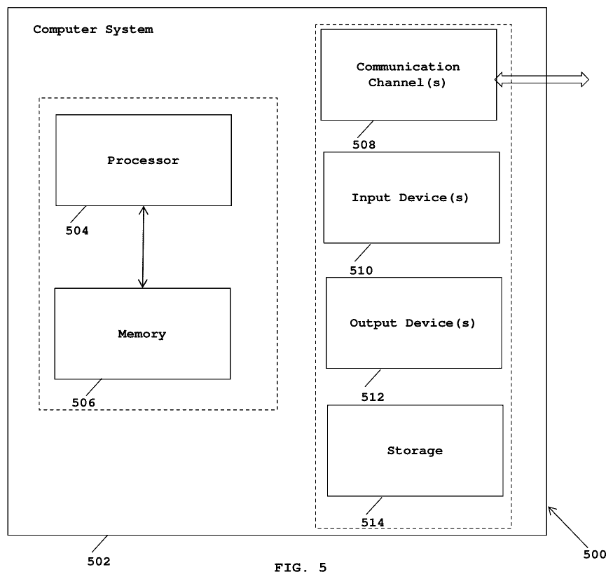

FIG. 5 illustrates an exemplary computer system in which various embodiments of the present invention may be implemented. The computer system 502 comprises a processor 504 and a memory 506. The processor 504 executes program instructions and is a real processor. The computer system 502 is not intended to suggest any limitation as to scope of use or functionality of described embodiments. For example, the computer system 502 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 506 may store software for implementing an embodiment of the present invention. The computer system 502 may have additional components. For example, the computer system 502 includes one or more communication channels 508, one or more input devices 510, one or more output devices 512, and storage 514. An interconnection mechanism (not shown) such as a bus, controller, or network, interconnects the components of the computer system 502. In an embodiment of the present invention, operating system software (not shown) provides an operating environment for various software executing in the computer system 502, and manages different functionalities of the components of the computer system 502.

The communication channel(s) 508 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 510 may include, but not limited to, a keyboard, mouse, pen, joystick, trackball, a voice device, a scanning device, touch screen or any another device that is capable of providing input to the computer system 502. In an embodiment of the present invention, the input device(s) 510 may be a sound card or similar device that accepts audio input in analog or digital form. The output device(s) 512 may include, but not limited to, a user interface on CRT or LCD, printer, speaker, CD/DVD writer, or any other device that provides output from the computer system 502.

The storage 514 may include, but not limited to, magnetic disks, magnetic tapes, CD-ROMs, CD-RWs, DVDs, flash drives or any other medium which can be used to store information and can be accessed by the computer system 502. In an embodiment of the present invention, the storage 514 contains program instructions for implementing the described embodiments.

The present invention may suitably be embodied as a computer program product for use with the computer system 502. The method described herein is typically implemented as a computer program product, comprising a set of program instructions which is executed by the computer system 502 or any other similar device. The set of program instructions may be a series of computer readable codes stored on a tangible medium, such as a computer readable storage medium (storage 514), for example, diskette, CD-ROM, ROM, flash drives or hard disk, or transmittable to the computer system 502, via a modem or other interface device, over either a tangible medium, including but not limited to optical or analogue communications channel(s) 508. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention.

We claim:

1. A system for optimized predictive risk assessment of software development lifecycle of projects, the system comprising:
a memory storing program instructions;
a processor executing program instructions stored in the memory; and
a risk estimation engine executed by the processor and configured to:
fetch an unstructured attribute dataset and group the unstructured attribute dataset based on derived Knowledge Performance Indicator (KPI) scores;
convert the unstructured attribute dataset into a structured attribute dataset by applying pre-defined rules, wherein each attribute data of the structured attribute dataset is mapped to pre-determined categorical values;
correlate a derived attribute data from the structured attribute dataset with a defined attribute data to derive an accuracy percentage, wherein the accuracy percentage signifies a potential risk to subsequent tasks in the software development lifecycle of projects;
implement a decision tree structure using the structured attribute dataset to predict spillover risk values;
apply an iterative logic to predict defect density values based on the structured attribute dataset; and
combine the KPI scores, the accuracy percentage and the spillover risk values and the defect density values for risk assessment in the software development lifecycle of projects to generate indicators of risks.

2. The system as claimed in claim 1, wherein the system comprises an unstructured data analysis unit configured to group the unstructured attribute dataset to create a grouped attribute dataset including a positive, a negative, a mixed and a neutral grouped sentiment dataset, the grouping is carried out by employing a sequence of computational linguistics techniques including stemming followed by tokenization on the unstructured attribute dataset comprising communication threads to create the grouped attribute dataset, and wherein the unstructured data analysis unit is configured to detect risks and initiate corrective actions on instances of a continuous non-positive grouped attribute outputs from a set of tasks for deriving the KPI scores, and wherein the unstructured data analysis unit performs analysis of the KPI score using Natural Language Processing (NLP), the communication thread is broken down into sub-component parts and the parts are individually validated to identify sentiment bearing phrases through word associations, the KPI score is assigned to each phrase in the sub-component parts such that the KPI score is proportional to a degree to which sentiment is expressed.

3. The system as claimed in claim 2, wherein the unstructured data analysis unit performs analysis of the KPI score to determine if the communication threads have KPI scores across multiple sentiments, and groups the unstructured attribute dataset comprising such communication threads as the mixed grouped sentiment dataset, and wherein the unstructured data analysis unit performs analysis of the KPI score and groups the unstructured attribute dataset comprising communication threads as a neutral grouped sentiment dataset in the event the KPI scores are determined to be low.

4. The system as claimed in claim 1, wherein the structured attribute dataset comprises a first attribute data representing unique requirement identifiers assigned by a standard project management system corresponding to the software development lifecycle of projects, and wherein the structured attribute dataset comprises a second attribute data representing base requirements provided by a team which is split at a functional or a technical level, and wherein the base requirements include modules and segments associated with User Interface (UI), database connectivity, error control, reporting that are required to build a software system corresponding to the software development lifecycle of projects.

5. The system as claimed in claim 1, wherein the structured attribute dataset comprises a third attribute data representing a count of number of days for completing technical or functional requirements in a work item, the third attribute is scaled in between a value of 1-8 days, and wherein the structured attribute dataset comprises a fourth attribute data representing an urgency of work items, sequence in which tasks are to be accomplished and a level of significance of the work items, the fourth attribute data may be represented as a major, a medium, a minor and a rush in a scale, wherein rush represents an ad-hoc requirement.

6. The system as claimed in claim 1, wherein the structured attribute dataset comprises a fifth attribute data representing a count of people that have worked or are working on a work item, wherein with increase in complexity in the software development lifecycle of projects a count of the fifth attribute data increases, and wherein the structured attribute dataset comprises a sixth attribute data representing a length of a field in a project management system comprising textual description of technical and functional requirements in words and characters.

7. The system as claimed in claim 1, wherein the structured attribute dataset comprises a seventh attribute data representing a count of a number of similar work items, tasks, bugs that have dependency on the work items, wherein a higher count indicates a higher complexity, and wherein the structured attribute dataset comprises an eighth attribute representing a count of number of times a closure of a work item is postponed on account of the work item not being completed within its due date, the eighth attribute is represented as a spill count that is a count of number of times the work item is not completed on time, the eighth attribute is represented as ‘no’ in the event the spill count is zero, ‘low’ in the event the spill count is one and requirement is completed, and ‘high’ in the event spill count is more than one and requirement is completed.

8. The system as claimed in claim 1, wherein the structured attribute dataset comprises a ninth attribute data that represents a count of number of comments logged amongst team members in a work item, the number of comments is determined by a number of people communicating in communication threads associated with the structured attribute dataset, and wherein the structured attribute dataset comprises a tenth attribute data representing an attachment count of artifacts signifying complexity within a work item, a higher count of attachments indicates complexity in the work item, and wherein the structured attribute dataset comprises an eleventh attribute data representing a count of defects found in a work item, and wherein the eleventh attribute represents bug occurrences in an unstructured data.

9. The system as claimed in claim 1, wherein the system comprises a data pre-processing unit configured to process the structured attribute dataset by performing standardisation of the structured attribute dataset via a z-transform technique, and wherein a scaled attribute data is generated by removing scaling biasness such that the z-transform is used to represent variability in one or more attribute data in the structured attribute dataset, and wherein the data pre-processing unit is configured to remove a plurality of standardised attributes from the structured attribute dataset, along with a Personal Identifiable Information (PII) and sensitive information through masking or conversion to metadata.

10. The system as claimed in claim 1, wherein the system comprises a correlation unit configured to correlate the derived attribute data with the defined attribute data to identify a significant gap in a derived story point and a defined story point that signifies a gap in an estimation analysis and consequently a potential risk to subsequent tasks, the derived attribute data is a pre-processed third attribute data that represents a rescaled value of a complexity noise, and wherein the correlation unit is configured to rescale the value of the derived third attribute data to a value of 1-8.

11. The system as claimed in claim 1, wherein the system comprises a predictability unit configured to fetch a pre-processed structured attribute dataset from a data pre-processing unit and execute a predictability model on the pre-processed structured attribute dataset based on pre-defined values, and wherein the predictability unit is configured to map each of the attribute data of the structured attribute dataset using the predictability model to different categorical values including the spillover risk values in terms of high, low, no and defect density in terms of high, medium, low or no, and wherein the predictability unit is configured to traverse decision nodes in the decision tree structure recursively using the predictability model, and wherein the predictability unit is configured to select an optimal split in the structured attribute dataset at each level in the decision tree structure until further splits are possible, and wherein a entropy reduction technique is employed to perform the optimal slit.

12. The system as claimed in claim 11, wherein the predictability unit is configured to construct the decision tree structure by selecting an attribute data of the structured attribute dataset as a parent root node and a parameter for splitting the decision tree structure to predict the spillover risk values, and wherein the spillover risk values indicate that an assigned task is spilled over an assigned deadline and is causing delay in the Software Development Life Cycle (SDLC) projects, and wherein the predictability unit is configured to split the parent root node into child nodes based on pre-defined threshold values, and wherein the predictability unit branches the decision tree structure and derives of a learning pattern that is applied to records of the structured attribute datasets, the records are classified as a risk or a non-risk record, and wherein the predictability unit repeats a process of determining information retention in the decision tree structure that results in an iterative nature of the predictability model, and wherein a second new attribute is determined and a second branching point (node) is created.

13. The system as claimed in claim 11, wherein the predictability unit is configured to apply the iterative logic to predict defect density values in the software development lifecycle of projects using a decision tree-based classifier with a target variable set to a derived project attribute where bug occurrences indicate number of valid defects found, and wherein the predictability unit re-uses the structured attribute data set to predict the defect density on a set of current or future tasks.

14. The system as claimed in claim 1, wherein the system comprises a risk estimation unit configured to fetch the KPI scores from an unstructured data analysis unit, the accuracy percentage from a correlation unit and the spillover risk values and defect density values from a predictability unit for risk assessment in the software development lifecycle of projects to detect causes for delay in the projects as the indicator of risks.

15. A method for optimized predictive risk assessment of software development lifecycle of projects, wherein the method is executed by a processor in communication with a memory, the method comprising:
fetching an unstructured attribute dataset and group the unstructured attribute dataset based on derived Knowledge Performance Indicator (KPI) scores to create a grouped attribute dataset;
converting the unstructured attribute dataset into a structured attribute dataset by applying pre-defined rules, wherein each attribute data of the structured attribute dataset is mapped to pre-determined categorical values;
correlating a derived attribute data from the structured attribute dataset with a defined attribute data to derive an accuracy percentage, wherein the accuracy percentage signifies a potential risk to subsequent tasks in the software development lifecycle of projects;
implementing a decision tree structure using the structured attribute dataset to predict spillover risk values;
applying an iterative logic to predict defect density values based on the structured attribute dataset; and
combining the KPI scores, the accuracy percentage and the spillover risk values and defect density values for risk assessment in the software development lifecycle of projects to generate indicators of risks.

16. The method as claimed in claim 15, wherein the grouped attribute dataset includes a positive, a negative, a mixed and a neutral grouped sentiment dataset, wherein the grouping is carried out by employing a sequence of computational linguistics techniques including stemming followed by tokenization on the unstructured attribute dataset comprising communication threads to create the grouped unstructured attribute dataset, the communication threads in the unstructured attribute dataset is broken down into sub-component parts and the parts are individually validated to identify sentiment bearing phrases through word associations, and wherein the KPI score is assigned to each phrase in the sub-component parts such that the KPI score is proportional to a degree to which sentiment is expressed.

17. The method as claimed in claim 15, wherein the derived attribute data is correlated with the defined attribute data to identify a significant gap in a derived story point and a defined story point which signifies a gap in an estimation analysis and consequently a potential risk to subsequent tasks, the derived attribute data is a pre-processed third attribute data which represents a rescaled value of a complexity noise, and wherein each of the attribute data of the structured attribute dataset is mapped using a predictability model to different categorical values including spillover values in terms of high, low, no and defect density in terms of high, medium, low or no.

18. The method as claimed in claim 15, wherein the decision tree structure is implemented by selecting an attribute data of the structured attribute dataset as a parent root node and a parameter for splitting the decision tree structure to predict the spillover risk values, wherein the spillover risk values indicate that an assigned task is spilled over an assigned deadline and is causing delay in the Software Development Life Cycle (SDLC) projects.

19. The method as claimed in claim 15, wherein the iterative logic is applied to predict defect density values in the software development lifecycle of projects using a decision tree-based classifier with a target variable set to a derived project attribute where bug occurrences indicate number of valid defects found.

20. A computer program product comprising:
a non-transitory computer-readable medium having computer program code stored thereon, the computer-readable program code comprising instructions that, when executed by a processor, causes the processor to:
fetch an unstructured attribute dataset and group the unstructured attribute dataset based on derived Knowledge Performance Indicator (KPI) scores;
convert the unstructured attribute dataset into a structured attribute dataset by applying pre-defined rules, wherein each attribute data of the structured attribute dataset is mapped to pre-determined categorical values;
correlate a derived attribute data from the structured attribute dataset with a defined attribute data to derive an accuracy percentage, wherein the accuracy percentage signifies a potential risk to subsequent tasks in the software development lifecycle of projects;
implement a decision tree structure using the structured attribute dataset to predict spillover risk values;
apply an iterative logic to predict defect density values based on the structured attribute dataset; and
combine the KPI scores, the accuracy percentage and the spillover risk values and defect density values for risk assessment in the software development lifecycle of projects to generate indicators of risks.
